(19) United States
(12) Patent Application Publication
(10) Pub. No.: US 2014/0017520 A1
(43) Pub. Date: Jan. 16, 2014

(54) ACTIVE MATERIAL, NONAQUEOUS ELECTROLYTE BATTERY, AND BATTERY PACK

(71) Applicant: KABUSHIKI KAISHA TOSHIBA, Minato-ku (JP)

(72) Inventors: Hiroki INAGAKI, Yokohama-shi (JP); Yasuhiro HARADA, Yokohama-shi (JP); Norio TAKAMI, Yokohama-shi (JP)

(21) Appl. No.: 13/940,820

(22) Filed: Jul. 12, 2013

(30) Foreign Application Priority Data
Jul. 12, 2012 (JP) 2012-156500

(51) Int. Cl. H01M 4/131; H01M 4/36

(52) U.S. Cl. CPC H01M 4/131; H01M 4/364
USPC 429/7; 429/225; 429/231.5; 252/182.1

(57) ABSTRACT

According to one embodiment, an active material includes an element M and a monoclinic crystal structure represented by the formula TiNb₂O₇. The element M includes at least one element selected from the group consisting of Mg, Ca, Sr, Ba, Pb, and P.

### CROSS-REFERENCE TO RELATED APPLICATIONS

This application is based upon and claims the benefit of priority from Japanese Patent Application No. 2012-156500, filed Jul. 12, 2012, the entire contents of which are incorporated herein by reference.

### FIELD

Embodiments described herein relate generally to active material, nonaqueous electrolyte battery and battery pack.

### BACKGROUND

Recently, a nonaqueous electrolyte battery such as a lithium-ion secondary battery has been developed as a battery having a high energy density. The nonaqueous electrolyte battery is expected to be used as a power source for hybrid vehicles or electric cars. Further, it is expected to be used as an uninterruptible power supply for base stations for portable telephone, and the like. For this, the nonaqueous electrolyte battery is desired to have other performances such as rapid charge and discharge performances and long-term reliability. For example, a nonaqueous electrolyte battery enabling rapid charge/discharge not only remarkably shortens the charging time but also makes it possible to improve performances of the motive force of a hybrid vehicle and to efficiently recover the regenerative energy of them.

In order to enable rapid charge/discharge, it is necessary that electrons and lithium ions can migrate rapidly between the positive electrode and the negative electrode. When a battery using a carbon based material in the negative electrode repeats rapid charge/discharge, dendrite precipitation of metal lithium is occurred on the electrode. Dendrite causes internal short circuits, which can lead heat generation and fires.

In light of this, a battery using a metal composite oxide as a negative electrode active material in place of a carbonaceous material has been developed. Particularly, in a battery using titanium oxide as the negative electrode active material, rapid charge/discharge can be performed stably. Such a battery also has a longer life than those using a carbonaceous material.

However, titanium oxide has a higher (nobler) potential based on metal lithium than the carbonaceous material. Further, titanium oxide has a lower capacity per weight. Thus, a battery using titanium oxide has a problem such that the energy density is low.

The potential of the electrode using titanium oxide is about 1.5 V based on metal lithium and is higher (nobler) than that of the negative electrode using the carbonaceous material. The potential of titanium oxide is due to the redox reaction between Ti³⁺ and Ti⁴⁺ when lithium is electrochemically inserted and released. Therefore, it is limited electrochemically. Further, there is the fact that rapid charge/discharge of lithium ion can be stably performed at an electrode potential as high as about 1.5 V. Therefore, it is substantially difficult to drop the potential of the electrode to improve energy density.

As to the capacity of the battery per unit weight, the theoretical capacity of a lithium-titanium composite oxide such as Li₄Ti₅O₁₂ is about 175 mAh/g. On the other hand, the theoretical capacity of a general graphite type electrode material is 372 mAh/g. Therefore, the capacity density of titanium oxide is significantly lower than that of the carbon type material. This is due to a reduction in substantial capacity because there are only a small number of lithium-absorbing sites in the crystal structure and lithium tends to be stabilized in the structure.

In view of such circumstances, a new electrode material containing Ti and Nb has been examined. Such a material is expected to have high charge and discharge capacity. Particularly, the theoretical capacity of a composite oxide represented by TiNb₂O₇ exceeds 300 mAh/g. However, high-temperature sintering at 1300 to 1400° C. is necessary to improve the crystallinity of a composite oxide such as TiNb₂O₇. This causes problems such as low productivity and poor rate performance.

### BRIEF DESCRIPTION OF THE DRAWINGS

FIG. 1 is a pattern diagram showing a crystal structure of monoclinic TiNb₂O₇;

FIG. 2 is a pattern diagram of the crystal structure of FIG. 1 as seen from another direction;

FIG. 3 is a cross-sectional view of a flat-shaped nonaqueous electrolyte battery according to a second embodiment;

FIG. 4 is an enlarged sectional view of an A portion of FIG. 3;

FIG. 5 is a partially cut perspective view schematically showing another flat-shaped nonaqueous electrolyte battery according to the second embodiment;

FIG. 6 is an enlarged sectional view of a B portion of FIG. 5;

FIG. 7 is an exploded perspective view of a battery pack according to a third embodiment; and

FIG. 8 is a block diagram showing the electric circuit of the battery pack of FIG. 7.

### DETAILED DESCRIPTION

According to one embodiment, an active material includes a monoclinic crystal structure represented by the formula TiNb₂O₇. The active material includes an element M including at least one element selected from the group consisting of Mg, Ca, Sr, Ba, Pb, and P.

According to the embodiments, a nonaqueous electrolyte battery includes a positive electrode, a negative electrode, and a nonaqueous electrolyte. The negative electrode contains the active material according to the embodiment.

According to the embodiments, a battery pack includes the nonaqueous electrolyte battery according to the embodiment.

Hereinafter, the embodiments will be described with reference to the drawings.

### First Embodiment

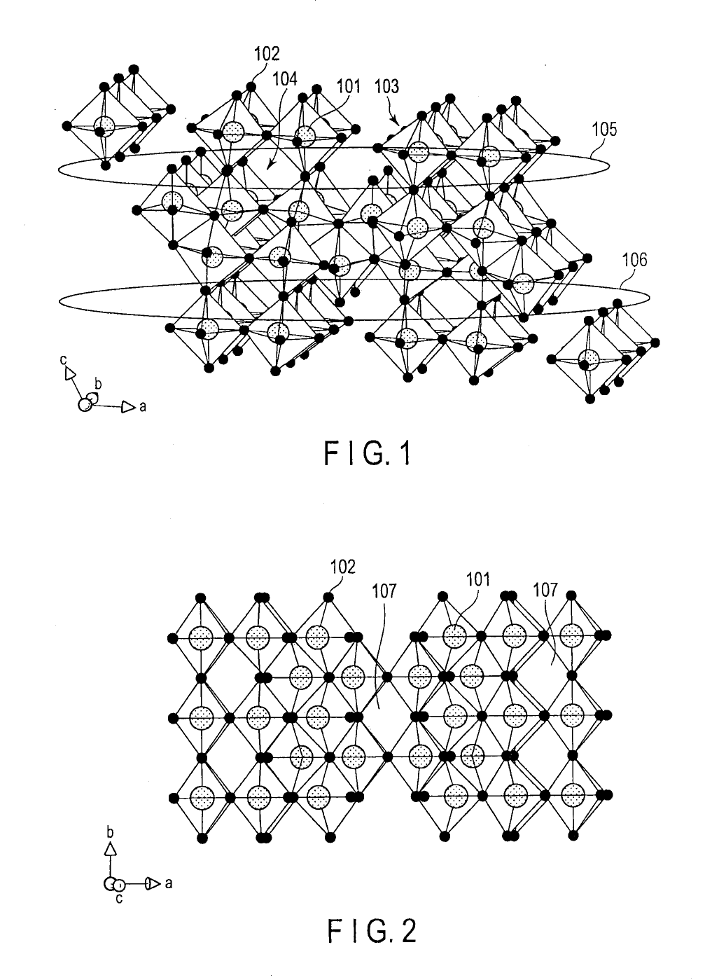

An active material for batteries according to a first embodiment has a monoclinic crystal structure represented by the formula TiNb₂O₇, and contains an element M of at least one selected from the group consisting of Mg, Ca, Sr, Ba, Pb, and P. The monoclinic crystal structure represented by the formula TiNb₂O₇ will be described with reference to FIG. 1.

As shown in FIG. 1, the crystal structure of monoclinic TiNb₂O₇ includes metal ions 101, oxide ions 102, and skeletal structures 103. Nb and Ti ions are randomly located in a metal ion 101 at a Nb/Ti ratio of 2:1. The skeletal structures 103 are arranged three-dimensionally alternately, and a void 104 is present between the skeletal structures 103. The void 104 serves as a host of lithium ion.

In FIG. 1, areas 105 and 106 are portions with two-dimensional channels in directions [100] and [010]. As shown in FIG. 2, in the crystal structure of monoclinic TiNb₂O₇, a void 107 is present in a direction [001]. The void 107 has a tunnel structure advantageous for the conduction of lithium ions and serves as a conduction path connecting the areas 105 and 106 in a [001] direction. Therefore, lithium ions can go back-and-forth between the areas 105 and 106 through the conduction path.

Thus, the monoclinic crystal structure has an equivalently large space into which lithium ions are inserted and has a structural stability. Further, the structure has two-dimensional channels enabling rapid diffusion of lithium ions and conduction paths connecting these channels in the direction [001]. Then, the lithium ions are inserted into and released from the insertion spaces effectively, and the insertion and release spaces for lithium ions are effectually increased. Therefore, the monoclinic crystal structure can provide a high capacity and high rate performance.

When lithium ions are inserted in the void 104, the metal ion 101 constituting the skeleton is reduced to a trivalent one, thereby maintaining electroneutrality of a crystal. In an oxide having a monoclinic crystal structure represented by the formula TiNb₂O₇, not only a Ti ion is reduced from tetravalent to trivalent but also an Nb ion is reduced from pentavalent to trivalent. For this, the number of reduced valences per active material weight is large. Therefore, the electroneutrality of the crystal can be maintained, even if many lithium ions are inserted. For this, the energy density of the oxide is higher than that of a compound only containing a tetravalent cation, such as titanium oxide. The theoretical capacity of the oxide having a monoclinic crystal structure represented by the formula TiNb₂O₇ is about 387 mAh/g and is more than twice the value of titanium oxide having a spinel structure.

The oxide having a monoclinic crystal structure represented by the formula TiNb₂O₇ has a lithium absorption potential of about 1.5 V (vs. Li/Li⁺). Therefore, a battery which is excellent in rate performance, is capable of stably repeating charge/discharge, and has high energy density can be provided by using the active material having a monoclinic crystal structure represented by the formula TiNb₂O₇.

The monoclinic crystal structure represented by the formula TiNb₂O₇ is not limited thereto and it may be a crystal structure having symmetry of space group C2/m and atomic coordination described in M. Gasperin, Journal of Solid State Chemistry 53, pp 144-147 (1984)

Incidentally, the oxide having a monoclinic crystal structure represented by the formula TiNb₂O₇ has a high melting point of about 1450° C. (see C. M. Reich et. al., FUEL CELLS No. 3-4, 1 pp 249-255 (2001)). Therefore, if a sintering process is performed at low temperatures in the synthesis of the oxide having a monoclinic crystal structure represented by the formula TiNb₂O₇, a low crystalline active material is obtained. The low crystalline active material has a low capacity and tends to exhibit poor rate performance (see Jpn. Pat. Appln. KOKAI Publication No. 2010-287496). Since high-temperature sintering at about 1300° C. is necessary to improve the crystallinity of the oxide having a monoclinic crystal structure represented by the formula TiNb₂O₇, the productivity is low. The crystallinity of the oxide is increased by high-temperature sintering. On the other hand, the grain growth is also facilitated, resulting in poor rate performance of the battery.

Further, many conventional electrode materials for batteries can be synthesized by sintering at about 600 to 1000° C. Therefore, the sintering at a high temperature as high as 1300° C. is not practicable in almost all of existing production facilities. In order to industrially produce the oxide having a monoclinic crystal structure represented by the formula TiNb₂O₇, it is necessary to introduce facilities where high-temperature sintering as about 1300° C. can be performed. This is very expensive.

When an element M comprising at least one selected from the group consisting of Mg, Ca, Sr, Ba, Pb, and P is added to the oxide having a monoclinic crystal structure represented by the formula TiNb₂O₇, the element M functions as a flux. Accordingly, high crystallinity can be obtained even by high- or low-temperature sintering. From the viewpoint of low-temperature sintering, the grain growth can be suppressed. As a result, the true density of the active material is increased. Thus, the bulk density of the active material in the electrode can be improved and the capacity of the electrode can be improved. Since the oxide has a microcrystal structure, it can increase the lithium absorption and release rate of the active material and improve the rate performance of the battery. All the elements listed above (used as the element M) are elements which do not occur the redox reaction at the charging and discharging potential of a battery comprising the oxide having a monoclinic crystal structure represented by the formula TiNb₂O₇ as the active material. Therefore, the element M can be suitably used because the potential flatness of the battery is not impaired. The element M more preferably comprises at least one of Sr and Ba.

The element M may exist as a solid solution in which a part of Nb in a crystal lattice represented by TiNb₂O₇ is substituted by the element M. Alternatively, the element M may not exist uniformly in the crystal lattice, but may exist in a segregated state among grains and/or in a domain. Alternatively, the element M in the form of an oxide (for example, SrO, BaO) may precipitate in the grain boundaries of a phase of the oxide having a monoclinic crystal structure represented by the formula TiNb₂O₇ (for example, TiNb₂O₇ phase). Further, the element M may exist in at least one state selected from the group consisting of a solid solution state, a segragated state and a state where a plurality of the elements precipitated in the grain boundaries. In any state, the melting point of the oxide having a monoclinic crystal structure represented by the formula TiNb₂O₇ can be dropped when the element M exists in the active material.

When the content of the active material is 100 atom %, the content of the element M in the active material is preferably from 0.01 to 10 atom %. The flux effect of the element M can be improved by setting the content to 0.01 atom % or more so that high crystallinity can be easily obtained. Preferably, the content is 0.03 atom % or more. The ratio of the impurity phase which does not contribute to the charge-discharge reaction can be suppressed by setting the content to 10 atom % or less. Thus, the quantity of electricity can be improved. Preferably, the content is 3 atom % or less.

### <Production Method>

The active material can be produced, for example, in the following manner.

First, starting materials are mixed. As the starting materials for the oxide having a monoclinic crystal structure represented by the formula TiNb₂O₇, oxides containing Ti and Nb or salts are used. As the starting materials for the element M, oxides containing at least one element selected from the group consisting of Mg, Ca, Sr, Ba, Pb, and P or salts are used. For example, when TiNb₂O₇ to which Sr is added is synthesized, oxides such as SrO, TiO₂, or Nb₂O₅ may be used as the starting materials. The salts used as the starting materials are preferably salts which decompose at relatively low temperatures to form oxides, like carbonate and nitrate.

Next, the obtained mixture is ground and blended as uniformly as possible. Then, the obtained mixture is sintered. The sintering is performed at a temperature range from 500 to 1200° C. for a total of 10 to 40 hours. According to this embodiment, even if the temperature is 1200° C. or less, a highly crystalline composite oxide can be obtained. More preferably, the sintering is performed at a temperature range from 800 to 1000° C. If the sintering temperature is 1000° C. or less, the existing facilities can be used.

The method allows the active material according to the embodiment to be obtained.

It is acceptable that the lithium ions are inserted by the charging of the battery and remain, as irreversible capacity, in the active material. Alternatively, a composite oxide containing lithium may be synthesized as the active material by using a compound containing lithium like lithium carbonate as a starting material. Therefore, the active material may contain the monoclinic oxide represented by LiₐTiNb₂O₇ (0≦a≦5).

### <Wide-Angle X-Ray Diffraction Measurement>

The crystal structure of the active material can be detected by the wide-angle X-ray diffraction (XRD).

The wide-angle X-ray diffraction measurement of the active material is performed as follows. First, a target sample is ground until the average particle diameter becomes about 5 μm. The average particle diameter can be determined by the laser diffractometry. A holder portion with a depth of 0.2 mm formed on a glass sample plate is filled with the ground sample. In this case, a care must be taken to fill the holder portion with the sample sufficiently. Further, a further care must be taken to prevent the occurrence of cracks and voids caused by a lack of the sample to be filled. Then, using a separate glass plate, the glass plate is sufficiently pressed against the sample from the outside to smooth the surface of the sample. In this case, a care must be taken to prevent the generation of parts convexed or concaved from the standard level of the holder due to a lack of the sample to be filled. Then, the glass plate filled with the sample is placed in a wide-angle X-ray diffractometer and a diffraction pattern is obtained using Cu-Kα rays.

When the orientation of the sample is high, the position of a peak may be shifted or the intensity ratio may be changed depending on the way of filling the sample. The sample is made into a pellet form for measurement. The pellet may be a compressed powder body for example, 10 mm in diameter and 2 mm in thickness. The compressed body may be manufactured by applying a pressure of about 250 MPa to the sample for 15 minutes. The obtained pellet is set to the X-ray diffractometer to measure the surface. The measurement using such a method eliminates a difference in the results of the measurement between operators, enabling high reproducibility.

When the wide-angle X-ray diffraction measurement is performed on the active material contained in the electrode, it can be performed, for example, as follows.

In order to analyze the crystal state of the active material, the active material is put into a state in which all lithium ions are released from the oxide having a monoclinic crystal structure represented by the formula TiNb₂O₇. When the active material is used, for example, in the negative electrode, the battery is put into a fully discharged state. However, there is the case where lithium ions remain even in a discharged state. Next, the battery is disintegrated in a glove box filled with argon. Then, the disintegrated battery is washed with an appropriate solvent. For example, ethyl methyl carbonate is preferably used as the solvent. The washed electrode may be cut into a size having the same area of the holder of the wide-angle X-ray diffractometer and attached directly to the glass holder. At this time, XRD is measured in advance with regard to the kind of the metallic foil of the electrode current collector to determine a position where a peak originating from the current collector appears. Furthermore, it is necessary to determine in advance whether or not there are peaks originating from the ingredients such as a conductive agent or binder. When the peak of the current collector is overlapped on the peak of the active material, it is desired to separate the active material from the current collector prior to the measurement. This is to separate the overlapped peaks and to measure the peak intensity quantitatively. Of course, the procedure may be omitted if these data have been determined in advance. Although the electrode may be separated physically, it is easily separated by applying ultrasonic wave in a solvent.

Then, the electrode recovered in this manner is subjected to the wide-angle X-ray diffraction to obtain WAXD pattern of the active material.

The results of the WAXD obtained in this manner are analyzed by the Rietveld method. In the Rietveld method, a diffraction pattern is calculated from a crystal structure model assumed in advance. Then, the diffraction pattern is fully fitted to actual values so as to improve the accuracy of parameters (for example, lattice constant, atomic coordination and occupation) relating to the crystal structure. Therefore, the characteristics of the crystal structure of the synthesized material can be investigated.

### <Confirmation of Content of Element M>

The content of the element M can be measured by ICP emission spectrometry. The measurement of the content of the element M by ICP emission spectrometry can be executed, for example, in the following manner. A battery is disassembled in a discharge state, and an electrode (for example, a negative electrode) is removed, followed by deactivation of the active material containing layer in water. Thereafter, the active material contained in the active material containing layer is extracted. The extraction treatment may be performed by removing a conductive agent and a binder in the active material containing layer by a heat treatment in air, for example. After transferring the extracted active material to a container, acid fusion or alkali fusion is performed to obtain a measurement solution. ICP emission spectroscopy of the measurement solution is conducted by using a measurement apparatus (for example, an SPS-1500V, manufactured by SII Nanotechnology Inc.) to measure the content of the element M.

It is acceptable that the active material according to the embodiment contains 1000 wt ppm of inevitable impurities in production, in addition to the element M.

### <Confirmation of State of Element M>

The state of the crystal phase is confirmed by wide-angle X-ray diffraction analysis so that it is possible to determine whether the added element M is substituted and dissolved. Specifically, the presence of impurity phases, changes in lattice constant (the ionic radius of the added element M is reflected) or the like can be determined. However, when it is added in a small amount, some cases cannot be determined by these methods. At that time, the distribution state of the added element can be found by TEM observation and EPMA measurement. Accordingly, it is possible to determine whether the added element is uniformly distributed in a solid or segregated.

### <Particle Diameter and BET Specific Surface Area>

The average particle diameter of the active material is not particularly limited and it may be changed according to desired battery characteristics. The BET specific surface area of the active material is not particularly limited and it is preferably 0.1 m²/g or more and less than 100 m²/g. If the specific surface area is 0.1 m²/g or more, the necessary contact area with the nonaqueous electrolyte can be ensured. Thus, excellent discharge rate performance is easily obtained. Further, the charging time can be reduced. On the other hand, if the specific surface area is less than 100 m²/g, the reactivity with the nonaqueous electrolyte does not become too high, and lifetime characteristics can be improved. In the process of producing an electrode, coating properties of a slurry containing the active material can be improved.

The specific surface area is measured using a method in which molecules whose molecular area at the monolayer is known are allowed to adsorb to the surface of powder particles at the temperature of liquid nitrogen to find the specific surface area of the sample from the amount of the adsorbed molecules. The most frequently used method is a BET method based on the low temperature and low humidity physical adsorption of an inert gas. The BET method is a famous theory as a calculation method of the specific surface area in which the Langmuir theory as a monolayer adsorption theory is extended to multilayer adsorption. The specific surface area determined by the BET method is called the “BET specific surface area”.

According to the active material according to the first embodiment, the material has the monoclinic crystal structure represented by the formula TiNb₂O₇ and contains the element M comprising at least one selected from the group consisting of Mg, Ca, Sr, Ba, Pb, and P. Thus, this allows for high productivity of the active material having excellent rate performance and high energy density.

### Second Embodiment

According to the second embodiment, there is provided a nonaqueous electrolyte battery including a negative electrode containing the active material according to the first embodiment, a positive electrode, and a nonaqueous electrolyte. The nonaqueous electrolyte battery of the second embodiment further includes a separator disposed between the negative electrode and the positive electrode; and an outer member which houses the positive and negative electrodes, the separator, and the nonaqueous electrolyte.

Hereinafter, the negative electrode, the positive electrode, the nonaqueous electrolyte, the separator, and the outer member will be described in detail.

### 1) Negative Electrode

The negative electrode includes a current collector and a negative electrode active material containing layer (negative electrode material layer). The negative electrode active material containing layer is formed on one side or both sides of the current collector. The layer includes the active material and arbitrarily includes the conductive agent and the binder.

The active material described in the first embodiment is used for the negative electrode active material. As the negative electrode active material, the active material described in the first embodiment may be used alone or in combination with other active materials. Examples of other active materials include titanium dioxide having an anatase structure (TiO₂), lithium titanate having a ramsdellite structure (for example, Li₂Ti₃O₇), and lithium titanate having a spinel structure (for example, Li₄Ti₅O₁₂).

The conductive agent is added to improve the current collection performance and suppress the contact resistance with the current collector. Examples of the conductive agent include carbonaceous substances such as acetylene black, carbon black, or graphite.

The binder is added to fill gaps of the dispersed negative electrode active material and bind the active material to the current collector. Examples of the binder include polytetrafluoroethylene (PTFE), polyvinylidene fluoride (PVdF), fluorine-based rubber, and styrene butadiene rubber.

Preferably, blending rates of the active material, the conductive agent, and the binder in the negative electrode active material containing layer are 68 to 96 mass %, 2 to 30 mass %, and 2 to 30 mass %, respectively. If the amount of the conductive agent is set to 2 mass % or more, the current collection performance of the negative electrode active material containing layer can be improved. If the amount of the binder is set to 2 mass % or more, the binding property of the negative electrode active material containing layer and the current collector is sufficient and excellent cycle characteristics can be expected. On the other hand, the amounts of the conductive agent and the binder are preferably set to 28 mass % or less from the viewpoint of high capacity performance.

A material which is electrochemically stable at the lithium absorption and release potential of the negative electrode active material is used for the current collector.

The current collector is preferably formed of copper, nickel, stainless steel or an aluminium, or an aluminium alloy containing at least one element selected from the group consisting of Mg, Ti, Zn, Mn, Fe, Cu, and Si. The thickness of the current collector is preferably from 5 to 20 μm. The current collector having such a thickness can achieve the strength and lightweight of the negative electrode.

The negative electrode may be produced by a method comprising suspending the negative active material, the binder, and the conductive agent in a widely used solvent to prepare a slurry, applying the slurry to the negative electrode current collector, drying to form a negative electrode active material containing layer, and pressing it. The negative electrode may also be produced by forming a pellet comprising the active material, the binder, and the conductive agent to produce a negative electrode active material containing layer and placing the layer on the current collector.

### 2) Positive Electrode

The positive electrode includes a current collector and a positive electrode active material containing layer (positive electrode material layer). The positive active material containing layer is formed on one side or both sides of the current collector. The layer includes the positive active material and arbitrarily includes the conductive agent and the binder.

Usable examples of the active material include oxides or sulfides. Examples of the oxides and sulfides include manganese dioxide capable of absorbing lithium (MnO₂), iron oxide, copper oxide, nickel oxide, a lithium manganese composite oxide (for example, LiₓMn₂O₄ or LiₓMnO₂), a lithium nickel composite oxide (for example, LiₓNiO₂), a lithium cobalt composite oxide (for example, LiₓCoO₂), a lithium nickel cobalt composite oxide (for example, LiNi_{1-y}Co_{y}O₂), a lithium manganese cobalt composite oxide (for example, LiₓMn_{y}Co_{1-y}O₂), a lithium-manganese-nickel composite oxide having a spinel structure (for example, LiₓMn_{2-y}Ni_{y}O₄), a lithium phosphorus oxide having an olivine structure (for example, LiₓFePO₄, LiₓFe_{1-y}Mn_{y}PO₄, LiₓCoPO₄), iron sulfate [Fe₂(SO₄)₃], a vanadium oxide (for example, V₂O₅), and a lithium nickel cobalt manganese composite oxide. In the above formula, x is more than 0 and 1 or less and y is more than 0 and 1 or less. As the active material, these compounds may be used alone or in combination with a plurality of compounds.

Examples of a more preferred active material include a lithium manganese composite oxide having a high positive electrode voltage (for example, LiₓMn₂O₄), a lithium nickel composite oxide (for example, LiₓNiO₂), a lithium cobalt composite oxide (for example, LiₓCoO₂), a lithium nickel cobalt composite oxide (for example, LiNi_{1-y}Co_{y}O₂), a lithium-manganese-nickel composite oxide having a spinel structure (for example, LiₓMn_{2-y}Ni_{y}O₄), a lithium manganese cobalt composite oxide (for example, Li_{X}Mn_{y}Co_{1-y}O₂), lithium iron phosphate (for example, LiₓFePO₄), and a lithium nickel cobalt manganese composite oxide. In the above formula, x is more than 0 and 1 or less and y is more than 0 and 1 or less.

The primary particle diameter of the positive electrode active material is preferably 100 nm or more and 1 μm or less. In the case of the positive electrode active material having a primary particle diameter of 100 nm or more, the handling in the industrial production is easy. In the case of the positive electrode active material having a primary particle diameter of 1 μm or less, diffusion in solid of lithium ions can be smoothly proceeded.

The specific surface area of the active material is preferably from 0.1 to 10 m²/g. In the case of the positive electrode active material having a specific surface area of 0.1 m²/g or more, the absorption and release site of lithium ions can be sufficiently ensured. In the case of the positive electrode active material having a specific surface area of 10 m²/g or less, the handling in the industrial production is made easy and good charge discharge cycle performance can be ensured.

The binder is used to bind the conductive agent to the active material. Examples of the binder include polytetrafluoroethylene (PTFE), polyvinylidene fluoride (PVdF), and fluorine-based rubber. The conductive agent is added, if necessary, to improve the current collection performance and suppress the contact resistance with the current collector. Examples of the conductive agent include carbonaceous substances such as acetylene black, carbon black, or graphite.

In the positive electrode active material containing layer, the active material and binder are preferably formulated in a ratio of 80% by mass or more and 98% by mass or less and in a ratio of 2% by mass or more and 20% by mass or less, respectively. When the amount of the binder is 2% by mass or more, sufficient electrode strength is obtained. Further, when the amount of the binder is 20% by mass or less, the amount of the insulating material of the electrode can be reduced, leading to reduced internal resistance. When the conductive agent is added, the active material, binder, and conductive agent are added in amounts of 77% by mass or more and 95% by mass or less, 2% by mass or more and 20% by mass or less and 3% by mass or more and 15% by mass or less respectively. When the amount of the conductive agent is 3% by mass or more, the above effect can be exerted. Further, when the amount of the conductive agent is 15% by weight or less, the decomposition of the nonaqueous electrolyte on the surface of the positive electrode conductive agent during storage at high temperatures can be reduced.

The current collector is preferably an aluminum foil or an aluminum alloy foil containing at least one element selected from the group consisting of Mg, Ti Zn, Ni, Cr, Mn, Fe, Cu, and Si.

The thickness of the aluminum foil or aluminum alloy foil is preferably 5 μm or more and 20 μm or less, more preferably 15 μm or less. The purity of the aluminum foil is preferably 99% by mass or more. The content of transition metals such as iron, copper, nickel, or chromium contained in the aluminum foil or aluminum alloy foil is set to, preferably 1% by mass or less.

The positive electrode may be produced by a method comprising suspending the active material, the binder, and the conductive agent to be added, if necessary in an appropriate solvent to prepare a slurry, applying the slurry to the positive electrode current collector, drying to form a positive electrode active material containing layer, and pressing it. The positive electrode may also be produced by forming a pellet comprising the active material, the binder, and the conductive agent to be added, if necessary, to produce a positive electrode active material containing layer, which is then placed on the current collector.

### 3) Nonaqueous Electrolyte

The nonaqueous electrolyte may be, for example, a liquid nonaqueous electrolyte prepared by dissolving an electrolyte in an organic solvent or a gel-like nonaqueous electrolyte prepared by forming a composite of a liquid electrolyte and a polymer material. The liquid nonaqueous electrolyte is preferably one which is prepared by dissolving an electrolyte in an organic solvent at a concentration of 0.5 to 2.5 mol/L.

Examples of the electrolyte include lithium salts such as lithium perchlorate (LiClO₄), lithium hexafluorophosphate (LiPF₆), lithium tetrafluoroborate (LiBF₄), arsenic lithium hexafluoride (LiAsF₆), lithium trifluoromethasulfonate (LiCF₃SO₃), lithium bis(trifluoromethylsulfonyl)imide [LiN(CF₃SO₂)₂], or the mixtures thereof. The electrolyte is preferably one which is not easily oxidized even at a high potential and LiPF₆ is the most preferable.

Examples of the organic solvent include cyclic carbonates such as propylene carbonate (PC), ethylene carbonate (EC), or vinylene carbonate; linear carbonates such as diethyl carbonate (DEC), dimethyl carbonate (DMC), or methylethyl carbonate (MEC); cyclic ethers such as tetrahydrofuran (THF), 2-methyltetrahydrofuran (2MeTHF), or dioxolane (DOX); linear ethers such as dimethoxyethane (DME) or diethoxyethane (DEE); and γ-butyrolactone (GBL), acetonitrile (AN), and sulfolane (SL). These organic solvents can be used alone or as a mixed solvent.

Examples of the polymer material include polyvinylidene fluoride (PVdF), polyacrylonitrile (PAN), and polyethylene oxide (PEO).

Alternatively, a room temperature molten salt containing lithium ions (ionic melt), polymer solid electrolyte, inorganic solid electrolyte and the like may be used as the nonaqueous electrolyte.

The room temperature molten salt (ionic melt) means compounds which can exist in a liquid state at room temperature (15 to 25° C.) among organic salts constituted of combinations of organic cations and anions. Examples of the room temperature molten salt include those which solely exist in a liquid state, those which are put into a liquid state when mixed with an electrolyte, and those which are put into a liquid state when dissolved in an organic solvent. The melting point of the room temperature molten salt to be usually used for the nonaqueous electrolyte battery is 25° C. or less. Further, the organic cation has generally a quaternary ammonium skeleton.

The polymer solid electrolyte is prepared by dissolving an electrolyte in a polymer material and by solidifying the mixture.

The inorganic solid electrolyte is a solid material having lithium ion-conductivity.

### 4) Separator

The separator may be formed of a porous film containing a material such as polyethylene, polypropylene, cellulose or polyvinylidene fluoride (PVdF), or a synthetic resin nonwoven fabric. Particularly, a porous film formed of polyethylene or polypropylene melts at a constant temperature and can block electric current, and thus it is preferred from the viewpoint of improvement in safety.

### 5) Outer Member

As the outer member, a container formed of a laminate film having a thickness of 0.5 mm or less or a container formed of metal having a thickness of 1 mm or less can be used. The thickness of the laminate film is more preferably 0.2 mm or less. The thickness of the metal container is preferably 0.5 mm or less, more preferably 0.2 mm or less.

The shape of the outer member may be flat-type (thin-type), square-type, cylindrical-type, coin-type, button-type or the like. The outer member may be, for example, an outer member for a small battery which is loaded into a portable electronic device or an outer member for a large battery which is loaded into a two- or four-wheeled vehicle, depending on the size of the battery.

As the laminate film, a multilayer film in which a metal layer is interposed between resin layers is used. The metal layer is preferably aluminum foil or aluminum alloy foil in order to reduce the weight. Polymer materials such as polypropylene (PP), polyethylene (PE), nylon, or polyethylene terephthalate (PET) can be used for the resin layer. The laminate film can be formed into a shape of the outer member by heat sealing.

The metal container is formed from aluminium or an aluminium alloy. It is preferable that the aluminium alloy includes elements such as magnesium, zinc, or silicon. When transition metals such as iron, copper, nickel, or chromium are contained in the alloy, the content is preferably 100 ppm or less.

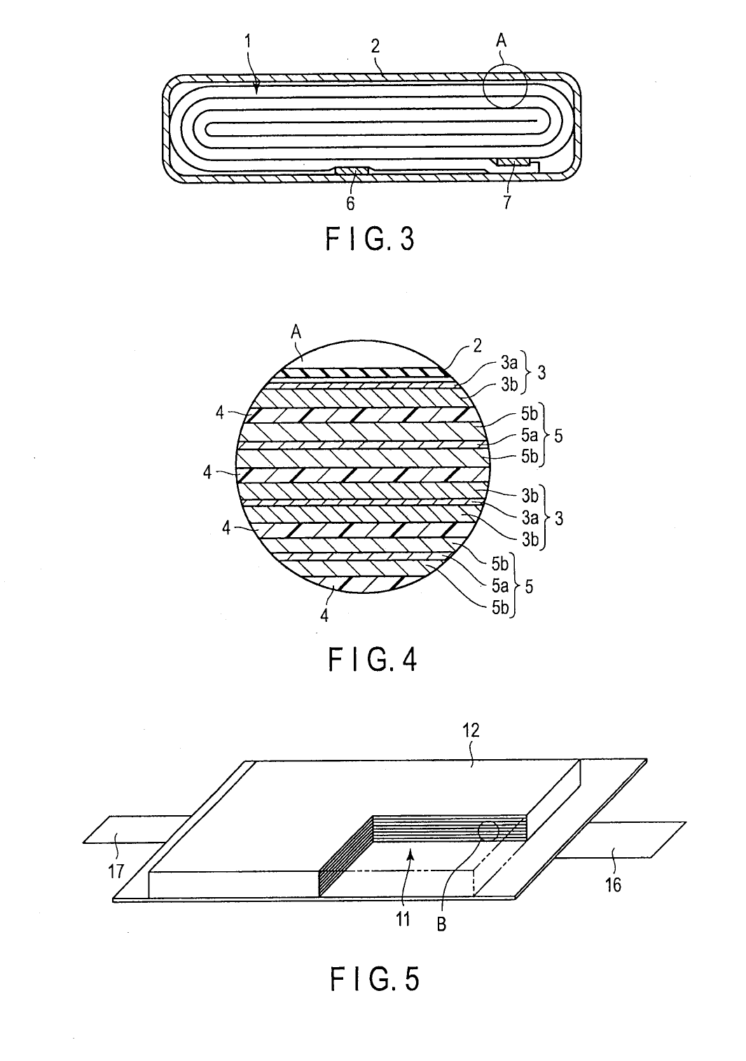

The nonaqueous electrolyte battery according to the second embodiment will be more specifically described with reference to the drawings. FIG. 3 is a cross-sectional view of a flat-shaped nonaqueous electrolyte battery. FIG. 4 is an enlarged sectional view of a portion A in FIG. 3. Each drawing is a pattern diagram to facilitate the description of the embodiments and its understanding. The shape, size, and ratio thereof are different from those of an actual device. However, they can be appropriately designed and modified by taking into consideration the following description and known techniques.

A flat-shaped wound electrode group 1 is housed in a bag-shaped outer member 2 formed of a laminate film in which a metal layer is interposed between two resin layers. As shown in FIG. 4, the flat-shaped wound electrode group 1 is formed by spirally winding a laminate obtained by stacking a negative electrode 3, a separator 4, a positive electrode 5, and the separator 4 in this order from the outside and subjecting it to press-molding.

The negative electrode 3 includes a negative electrode current collector 3a and a negative electrode active material containing layer 3b. The negative electrode active material is contained in the negative electrode active material containing layer 3b. As shown in FIG. 4, the negative electrode 3 on the outermost layer has a configuration in which the negative electrode active material containing layer 3b is formed at only one side of the inner surface of the negative electrode current collector 3a. In other negative electrodes 3, the negative electrode active material containing layer 3b is formed at both sides of the negative electrode current collector 3a. In the positive electrode 5, the positive electrode active material containing layer 5b is formed at both sides of the positive electrode current collector 5a.

As shown in FIG. 3, in a vicinity of a peripheral edge of the wound electrode group 1, a negative electrode terminal 6 is connected to the negative electrode current collector 3a of the negative electrode 3 of an outermost shell layer, and a positive electrode terminal 7 is connected to the positive electrode current collector 5a of the positive electrode 5 at the inside. The negative electrode terminal 6 and the positive electrode terminal 7 are extended outwardly from an opening of the bag-shaped outer member 2. For example, the liquid nonaqueous electrolyte is injected from the opening of the bag-shaped outer member 2. The wound electrode group 1 and the liquid nonaqueous electrolyte can be completely sealed by heat-sealing the opening of the bag-shaped outer member 2 across the negative electrode terminal 6 and the positive electrode terminal 7.

The negative electrode terminal 6 is formed from a material which is electrically stable in Li absorption-release potential of the negative electrode active material and has conductivity. Specific examples thereof include copper, nickel, stainless steel, and aluminium. It is preferable that the negative electrode terminal 6 is formed from the same material as that of the negative electrode current collector 3a in order to reduce the contact resistance with the negative electrode current collector 3a.

The positive electrode terminal 7 can be formed of, for example, a material having electric stability and conductivity in a potential range (3 to 5 V (vs.Li/Li⁺)). Specifically, it is formed from aluminium or an aluminium alloy containing an element such as Mg, Ti, Zn, Mn, Fe, Cu or Si. It is preferable that the positive electrode terminal 7 is formed from the same material as that of the positive electrode current collector 5a in order to reduce the contact resistance with the positive electrode current collector 5a.

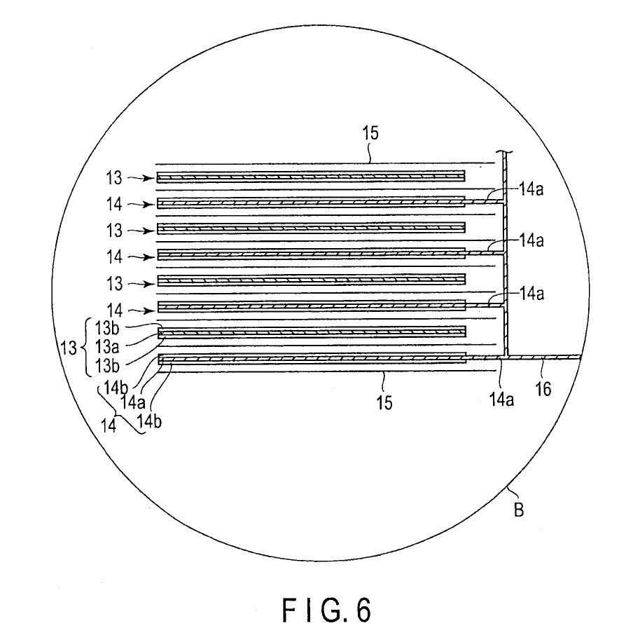

The nonaqueous electrolyte secondary battery according to the second embodiment may have not only the configurations shown in FIGS. 3 and 4, but also the configurations shown in FIGS. 5 and 6. FIG. 5 is a partially cut perspective view schematically showing another flat-shaped nonaqueous electrolyte battery according to the second embodiment. FIG. 6 is an enlarged sectional view of a B portion of FIG. 5.

The lamination-type electrode group 11 is housed in an outer member 12 which is formed of a laminate film in which a metal layer is interposed between two resin films. As shown in FIG. 6, the lamination-type electrode group 11 has a structure in which a positive electrode 13 and a negative electrode 14 are alternately stacked while a separator 15 is interposed between the both electrodes. A plurality of the positive electrodes 13 are present and they comprise the current collector 13a and a positive electrode active material containing layer 13b formed at both sides of the current collector 13a. A plurality of the negative electrodes 14 are present and they comprise a negative electrode current collector 14a and a negative electrode active material containing layer 14b formed at both sides of the negative electrode current collector 14a. In each of the negative electrode current collectors 14a of the negative electrodes 14, a side is protruded from the negative electrode 14. The protruded negative electrode current collector 14a is electrically connected to a belt-like negative electrode terminal 16. The distal end of the negative electrode terminal 16 is externally drawn from the outer member 11. In the positive electrode current collector 13a of the positive electrode 13, not illustrated, one side located at the opposite side of the protruded side of the negative electrode current collector 14a is protruded from the positive electrode 13. The positive electrode current collector 13a protruded from the positive electrode 13 is electrically connected to a belt-like positive electrode terminal 17. The distal end of the belt-like positive electrode terminal 17 is located at the opposite side of the negative electrode terminal 16 and externally drawn from the outer member 11.

According to the nonaqueous electrolyte battery according to the second embodiment, the battery comprises the negative electrode containing the active material according to the first embodiment. Thus, there can be provided a nonaqueous electrolyte battery having excellent productivity and rate performance and high energy density.

### Third Embodiment

Subsequently, the battery pack according to the third embodiment will be with reference to the drawings. The battery pack according to the third embodiment has one or a plurality of nonaqueous electrolyte batteries (unit cells) according to the second embodiment. When a plurality of the unit cells is included, each of the unit cells is electrically connected in series or in parallel.

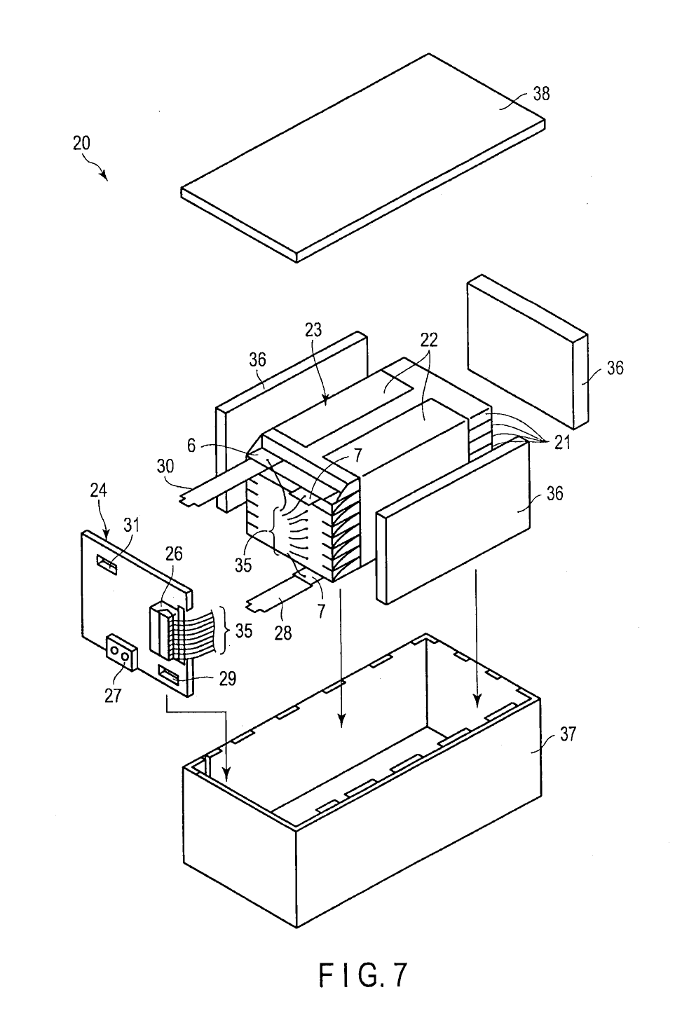

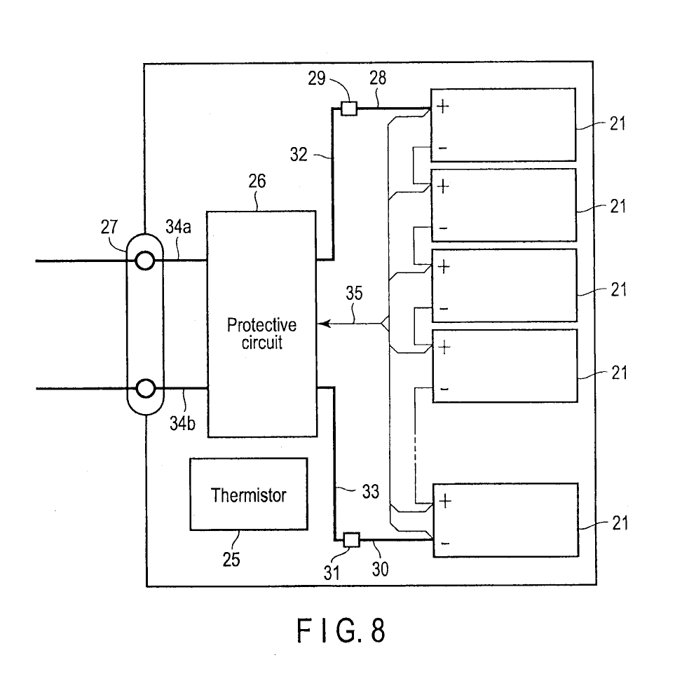

FIG. 7 and FIG. 8 show an example of a battery pack 20.

The battery pack 20 includes a plurality of flat-type batteries 21 having the structure shown in FIG. 1. FIG. 7 is an exploded perspective view of the battery pack 20. FIG. 8 is a block diagram showing an electric circuit of the battery pack 20 of FIG. 7.

An battery module 23 is configured by stacking the unit cells 21 so that a negative electrode terminal 6 extended outside and a positive electrode terminal 7 extended outside are arranged in the same direction and fastening them with an adhesive tape 22. The unit cells 21 are electrically connected in series as shown in FIG. 8.

A printed wiring board 24 is arranged opposed to the side surface of the unit cells 21 where the negative electrode terminal 6 and the positive electrode terminal 7 are extended. A thermistor 25, a protective circuit 26, and an energizing terminal 27 to an external instrument are mounted on the printed wiring board 24 as shown in FIG. 8. An electric insulating plate (not shown) is attached to the surface of the printed wiring board 24 facing the battery module 23 to avoid unnecessary connection of the wiring of the battery module 23.

A positive electrode-side lead 28 is connected to the positive electrode terminal 7 located at the bottom layer of the battery module 23 and the distal end is inserted into a positive electrode-side connector 29 of the printed wiring board 24 so as to be electrically connected. An negative electrode-side lead 30 is connected to the negative electrode terminal 6 located at the top layer of the battery module 23 and the distal end is inserted into an negative electrode-side connector 31 of the printed wiring board 24 so as to be electrically connected. The connectors 29 and 31 are connected to the protective circuit 26 through wirings 32 and 33 formed in the printed wiring board 24.

The thermistor 25 detects the temperature of the unit cells 21 and the detection signal is sent to the protective circuit 26. The protective circuit 26 can shut down a plus-side wiring 34a and a minus-side wiring 34b between the protective circuit 26 and the energizing terminals 27 to an external instrument under a predetermined condition. For example, the predetermined condition indicates when the detection temperature of the thermistor 25 becomes more than a predetermined temperature. Or, the predetermined condition indicates when the overcharge, overdischarge, and over-current of the unit cells 21 are detected. The overcharge detection may be performed on each of the unit cells 21 or the whole of the unit cells 21. When each of the unit cells 21 is detected, the cell voltage may be detected, or positive electrode or negative electrode potential may be detected. In the case of the latter, a lithium electrode to be used as a reference electrode is inserted into each of the unit cells 21. In the case of FIGS. 7 and 8, wirings 35 for voltage detection are connected to the unit cells 21 and detection signals are sent to the protective circuit 26 through the wirings 35.

Protective sheets 36 comprising rubber or resin are arranged on three side surfaces of the battery module 23 except the side surface in which the positive electrode terminal 7 and the negative electrode terminal 6 are protruded.

The battery module 23 is housed in a housing container 37 together with each of the protective sheets 36 and the printed wiring board 24. That is, the protective sheets 36 are arranged on both internal surfaces in a long side direction of the housing container 37 and on one of the internal surface at the opposite side in a short side direction. The printed wiring board 24 is arranged on the other internal surface in a short side direction. The battery module 23 is located in a space surrounded by the protective sheets 36 and the printed wiring board 24. A lid 38 is attached to the upper surface of the housing container 37.

In order to fix the battery module 23, a heat-shrinkable tape may be used in place of the adhesive tape 22. In this case, the battery module is bound by placing the protective sheets on the both sides of the battery module, revolving the heat-shrinkable tube, and thermally shrinking the heat-shrinkable tube.

In FIGS. 7 and 8, the form in which the unit cells 21 are connected in series is shown. However, in order to increase the battery capacity, the cells may be connected in parallel. Alternatively, the cells may be formed by combining series connection and parallel connection. The battery module pack can be connected in series or in parallel.

The form of the battery pack is appropriately changed according to the use. The battery pack is used suitably for the application which requires the excellent cycle characteristics at a high current. It is used specifically as a power source for digital cameras, for vehicles such as two- or four-wheel hybrid electric vehicles, for two- or four-wheel electric vehicles, and for assisted bicycles. Particularly, it is suitably used as a battery for automobile use.

According to the third embodiment, the nonaqueous electrolyte battery of the second embodiment is included. Thus, there can be provided a battery pack having excellent productivity and rate performance and high energy density.

### EXAMPLES

Hereinafter, the embodiments will be described in detail based on examples. The identification of the crystal phase and estimation of crystal structure of the synthesized oxide were performed by the wide-angle X-ray diffraction using Cu-Kα rays. The composition of the product was analyzed by the ICP method to confirm whether a target product was obtained or not.

### Example 1

### <Production of Titanium Composite Oxide>

First, niobium oxide (Nb₂O₅), strontium oxide (SrO₂), and anatase type titanium oxide (TiO₂) were mixed, followed by sintering of the obtained mixture at 1000° C. for 24 hours to obtain an oxide having a monoclinic crystal structure represented by the formula TiNb₂O₇ and containing Sr. The obtained oxide was subjected to particle size adjustment by dry pulverization using zirconia beads to obtain an active material.

The X-ray diffraction was performed on the obtained active material under the following conditions. As a result, it was confirmed that the material was an active material containing an oxide having a monoclinic crystal structure represented by the formula TiNb₂O₇ as a main phase.

### <Measurement Method>

A standard glass holder having a diameter of 25 mm was filled with a sample, and a measurement was conducted by employing the wide-angle X-ray diffraction. A measurement apparatus and conditions are described below.

(1) X-ray diffraction apparatus: D8 Advance (tube type) manufactured by Bruker AXS.

X-ray source: CuKα rays (using Ni filter)

Output: 40 kV, 40 mA

Slit system: Div. Slit; 0.3°

Detector: LynxEye (high speed detector)

(2) Scanning method: 2θ/θ, continuous scanning
(3) Measurement range (2θ): 5 to 100°
(4) Step width (2θ): 0.01712°
(5) Counting time: 1 s/step

The concentration of Sr in the obtained active material was measured by ICP emission spectrometry. As a result, it was confirmed that the concentration of Sr was 0.01 atom % based on 100 atom % of the active material.

### <Production of Electrode>

A slurry was prepared by adding 90 wt % of the obtained active material powder, 5 wt % of acetylene black as a conductive agent, and 5 wt % of polyvinylidene fluoride (PVdF) N-methylpyrrolidone (NMP) and mixing. The slurry was applied on both surfaces of a current collector made from an aluminum foil having a thickness of 15 μm, followed by drying. Thereafter, a negative electrode having an electrode density of 2.4 g/cm³ was produced by pressing.

### <Preparation of Liquid Nonaqueous Electrolyte>

Ethylene carbonate (EC) and ethylmethyl carbonate (EMC) were mixed at a volume ratio of 1:2 to obtain a mixed solvent. LiPF₆ which was an electrolyte was dissolved at a concentration of 1M in the mixed solvent to prepare a liquid nonaqueous electrolyte.

### <Production of Beaker Cells>

The produced electrode was used as a working electrode. A beaker cell in which lithium metal was used for a counterelectrode and a reference electrode was produced. The liquid nonaqueous electrolyte was injected to complete the beaker cell.

### Comparative Example 1 and Examples 2 to 6

An active material was synthesized in the same manner as in Example 1 except that the content of Sr in the active material was changed as described in Table 1 in order to complete a beaker cell.

### Comparative Example 2

An active material was synthesized in the same manner as in Comparative example 1 except that the sintering temperature of the active material was set to 1350° C. in order to complete a beaker cell.

### Examples 7 to 12

An active material was synthesized in the same manner as in Examples 1 to 6 except that BaO was used in place of SrO in order to complete a beaker cell.

### Examples 13 to 16

An active material was synthesized in the same manner as in Example 5 except that MgO, CaO, PbO, and P₂O₅ were used in place of SrO in order to complete a beaker cell.

The obtained beaker cells of Examples 1 to 16 as well as the beaker cells of Comparative examples 1 to 2 were subjected to charge/discharge cycles at a potential range from 1 to 3 (V vsLi/Li⁺) in an environment of 25° C. The capacity at 0.2 C per the unit mass of the active material and the capacity at 1.0 C per the unit mass of the active material were determined. The capacity at 0.2 C and a ratio X (%) are shown in Table 1. The ratio X (%) is calculated from Z/Y when the capacity at 0.2 C (MAh/g) is Y (mAh/g), and the capacity at 1.0 C (MAh/g) is Z (mAh/g).

TABLE 1

| | Added | Additive amount | Capacity at 0.2 C | X |
|---|---|---|---|---|
| | element | (atom %) | (mAh/g) | (%) |
| Example 1 | Sr | 0.01 | 259 | 97 |
| Example 2 | Sr | 0.03 | 265 | 98 |
| Example 3 | Sr | 0.11 | 270 | 99 |
| Example 4 | Sr | 0.31 | 267 | 99 |
| Example 5 | Sr | 1.02 | 265 | 98 |
| Example 6 | Sr | 2.99 | 257 | 98 |
| Comparative | — | — | 243 | 95 |
| Example 1 | | | | |
| Comparative | — | — | 250 | 88 |
| Example 2 | | | | |
| Example 7 | Ba | 0.01 | 256 | 97 |
| Example 8 | Ba | 0.03 | 264 | 98 |
| Example 9 | Ba | 0.10 | 264 | 99 |
| Example 10 | Ba | 0.29 | 263 | 99 |
| Example 11 | Ba | 1.01 | 259 | 99 |
| Example 12 | Ba | 2.99 | 257 | 98 |
| Example 13 | Mg | 0.99 | 259 | 98 |
| Example 14 | Ca | 1.00 | 260 | 98 |
| Example 15 | Pb | 1.00 | 261 | 99 |
| Example 16 | P | 1.02 | 259 | 98 |

As is clear from Table 1, it is found that the active materials for batteries of Examples 1 to 16 which do not contain the element M have a higher capacity than the active material for batteries of Comparative example 1 which does not contain the element M. It is found that Comparative example 2 in which the crystallinity is improved at 1350° C. has a low ratio X (%) of the capacity at 1.0 C to the capacity at 2 C as compared with Examples 1 to 16 and is inferior to rate performance (i.e., high current performance).

When Examples 1 to 6 are compared, it is found that Examples 2 to 6 in which the additive amount of the element M is from 0.03 to 3 atom % are excellent in rate performance as compared with Example 1 in which the additive amount of the element M is 0.01 atom %. When Examples 7 to 12 are compared, it is found that Examples 8 to 12 in which the additive amount of the element M is from 0.03 to 3 atom % are excellent in rate performance as compared with Example 7 in which the additive amount of the element M is 0.01 atom %.

According to the active materials of the embodiments or the examples, they have the monoclinic crystal structure represented by the formula TiNb₂O₇ and contain the element M comprising at least one selected from the group consisting of Mg, Ca, Sr, Ba, Pb, and P, and thus it is possible to realize a battery having excellent rate performance and high energy density.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An active material comprising: a monoclinic crystal structure represented by the formula TiNb₂O₇; and an element M comprising at least one element selected from the group consisting of Mg, Ca, Sr, Ba, Pb, and P.

2. The active material according to claim 1, wherein the element M comprises at least one of Sr and Ba.

3. The active material according to claim 1, wherein a content of the element M is from 0.01 to 10 atom %.

4. The active material according to claim 1, wherein the content of the element M is from 0.03 to 3 atom %.

5. The active material according to claim 1, further comprising an oxide of the element M.

6. The active material according to claim 1, further comprising a solid solution comprising the element M.

7. The active material according to claim 1, which comprises at least one of grains and domains, wherein the element M exists among the grains and/or in the domains.

8. A nonaqueous electrolyte battery comprising:
a positive electrode;
a negative electrode comprising the active material according to claim 1; and
a nonaqueous electrolyte.

9. The battery according to claim 8, wherein the negative electrode comprises at least one oxide selected from the group consisting of a titanium dioxide having an anatase structure, a lithium titanate having a ramsdellite structure, and a lithium titanate having a spinel structure.

10. The battery according to claim 8, wherein the battery is used for vehicles.

11. A battery pack comprising the nonaqueous electrolyte battery according to claim 8.

12. The battery pack according to claim 11, further comprising a protective circuit capable of detecting the voltage of the nonaqueous electrolyte battery.
